(19) United States
(12) Patent Application Publication
(10) Pub. No.: US 2015/0089606 A1
(43) Pub. Date: Mar. 26, 2015

(54) AREA RESTRICTED NETWORK MANAGEMENT METHOD AND DEVICE AS WELL AS AREA KEY RECEIPT METHOD AND DEVICE

(71) Applicants: Wei WANG, Beijing (CN); Bin DA, Beijing (CN); Haihua YU, Beijing (CN); Yindong ZHANG, Beijing (CN); Linju YANG, Beijing (CN)

(72) Inventors: Wei WANG, Beijing (CN); Bin DA, Beijing (CN); Haihua YU, Beijing (CN); Yindong ZHANG, Beijing (CN); Linju YANG, Beijing (CN)

(73) Assignee: RICOH COMPANY, LTD., Tokyo (JP)

(21) Appl. No.: 14/489,647

(22) Filed: Sep. 18, 2014

(30) Foreign Application Priority Data
Sep. 23, 2013 (CN) 201310435574.7

(51) Int. Cl. H04W 12/08; H04W 76/02; H04L 29/06; H04W 12/04

(52) U.S. Cl. CPC H04W 12/08; H04W 12/04; H04W 76/023; H04L 63/062
USPC 726/5

(57) ABSTRACT

Disclosed is an area restricted network management method including a step of detecting, in a first area restricted network, one or more second area keys sent from one or more second area restricted networks; a step of generating a first hierarchical area key which is related to a first area key generated by the first area restricted network as well as at least one of the detected one or more second area keys; and a step of transmitting the first hierarchical area key to inside of the first area restricted network.

### BACKGROUND OF THE INVENTION

1. Field of the Invention

The present invention relates to an area restricted network technique, and particularly relates to an area restricted network management method and device as well as an area key receipt method and device.

2. Description of the Related Art

With the development of wireless communications technologies, various applications of mobile devices such as cellular phones, notebook computers, tablet computers, smart phones, and game machines have been developed. As a result, for example, in the field of Peer to Peer (P2P) wireless communications, it is necessary to study the communications security of the mobile devices.

In U.S. Pat. No. 8,350,666 B2, a method including receiving wireless signals from a device at a wireless access point associated with a wireless network is disclosed. The method also includes estimating a location of the device and determining whether the estimated location is within a specified area. In addition, the method includes allowing the device to communicate over the wireless network in response to determining that the estimated location is within the specified area. However, in the method, only the device is considered whether or not to enter the specified area. That is to say, the method cannot solve the security issues of communications devices in a case where a hierarchical area restricted network including plural area restricted networks located in different layers exists.

In U.S. Pat. No. 8,305,935 B2, a system for dynamic information exchange on mesh network devices is disclosed. The dynamic information exchange includes allowing a mesh network device to communicate location information with a network device at predetermined physical location and invite social contacts of the mesh network device to come to the predetermined physical location. The network device sends various types of electronic messages on a mesh network and to social network sites. However, in the system, only the mesh network and mesh network device are used for determining the location of the network device, and the physical location of only one network device is taken into account. That is to say, the system cannot solve the security issues of communications devices in a case where a hierarchical area restricted network including plural area restricted networks located in different layers exists.

Moreover, in U.S. Pat. No. 7,676,236 B2, an ad hoc network with distributed hierarchical scheduling is disclosed. The ad hoc network may be organized into a tree topology. Distributed, hierarchical scheduling is provided where parents schedule communications with children while respecting already scheduled transmissions to/from interferers and to/from interferers of their respective children. However, in the ad hoc network, only data transmissions between the interferers in various mesh networks are considered. That is to say, the ad hoc network cannot solve the security issues of communications devices in a case where a hierarchical area restricted network including plural area restricted networks located in different layers exists.

### SUMMARY OF THE INVENTION

According to a first aspect of the present invention, an area restricted network management method is provided. The method includes:

a step of detecting, in a first area restricted network, one or more second area keys sent from one or more second area restricted networks;

a step of generating a first hierarchical area key which is related to a first area key generated by the first area restricted network as well as at least one of the detected one or more second area keys; and

a step of transmitting the first hierarchical area key to the inside of the first area restricted network.

According to a second aspect of the present application, an area key receipt method is provided.

The method includes:

a step of receiving, in a first area restricted network, one or more second hierarchical area keys sent from one or more second area restricted networks, wherein, the one or more second hierarchical area keys are managed by the area restricted network management method according to the first aspect of the present invention;

a step of analyzing the one or more second hierarchical area keys so as to determine in which second area restricted network or networks a device within the first area restricted network is located; and

a step of communicating, by the node within the first area restricted network, with one or more devices in the determined second area restricted network or networks by utilizing a first hierarchical area key managed by the area restricted network management method according to the first aspect of the present invention or the one or more second hierarchical area keys.

According to a third aspect of the present invention, an area restricted network management device is provided. The device includes:

a detection part configured to detect, in a first area restricted network, one or more second area keys sent from one or more second area restricted networks;

a generation part configured to generate a first hierarchical area key which is related to a first area key generated by the first area restricted network as well as at least one of the detected one or more second area keys; and

a transmission part configured to transmit the first hierarchical area key to the inside of the first area restricted network.

According to a fourth aspect of the present invention, an area key receipt device is provided. The device includes:

a receipt part configured to receive, in a first area restricted network, one or more second hierarchical area keys sent from one or more second area restricted networks, wherein, the one or more second hierarchical area keys are managed by the area restricted network management method according to the first aspect of the present invention;

an analysis part configured to analyze the one or more second hierarchical area keys so as to determine in which second area restricted network or networks the area key receipt device is located; and

a communications part configured to communicate with one or more devices in the determined second area restricted network or networks by utilizing a first hierarchical area key managed by the area restricted network management method according to the first aspect of the present invention or the one or more second hierarchical area keys.

### BRIEF DESCRIPTION OF THE DRAWINGS

FIG. 1A illustrates a concept of an area restricted network;

FIG. 1B illustrates an application environment of a hierarchical area restricted network;

FIG. IC illustrates a process of managing the communications between a master node and a slave node in a single area restricted network;

FIG. 2 is a flowchart of an area restricted network management method according to an embodiment of the present invention;

FIGS. 3A to 3D illustrate a hierarchical area key passing method used in a hierarchical area restricted network according to an embodiment of the present invention;

FIG. 4 is a flowchart of a method of establishing a hierarchical area restricted network according to an embodiment of the present invention;

FIG. 5 is a flowchart of an area key receipt method according to an embodiment of the present invention;

FIG. 6 is a block diagram of an area key receipt node according to an embodiment of the present invention;

FIG. 7 is a flowchart of a method of performing authorization by utilizing a hierarchical area key obtained according to an embodiment of the present invention;

FIGS. 8A to 8C illustrate communications performed on the basis of a hierarchical area key obtained according to an embodiment of the present invention;

FIG. 9 is a block diagram of an area restricted network management device according to an embodiment of the present invention; and

FIG. 10 is a block diagram of an area key receipt device according to an embodiment of the present invention.

### DETAILED DESCRIPTION OF THE PREFERRED EMBODIMENTS

In order to let those people skilled in the art better understand the present invention, hereinafter the present invention will be concretely described on the basis of the drawings and various embodiments.

Here it should be noted that the so-called “area restricted network (ARN)” (sometimes, also called an “area restricted ad hoc network”) in this specification refers to a kind of network whose area may be limited (determined or defined) and adjusted artificially in a physical way. The area restricted network may be limited by one or more single transmitters. An example of the area restricted network is an area limited by the intersection of infrared rays transmitted by one or more infrared ray transmitters, an area limited by the intersection of light beams transmitted by one or more light transmitters (for example, light emitting diodes (LEDs)), an area limited by the intersection of microwaves transmitted by one or more microwave transmitters, an area limited by utilizing a near field communication (NFC) technique, or an area limited by other signals.

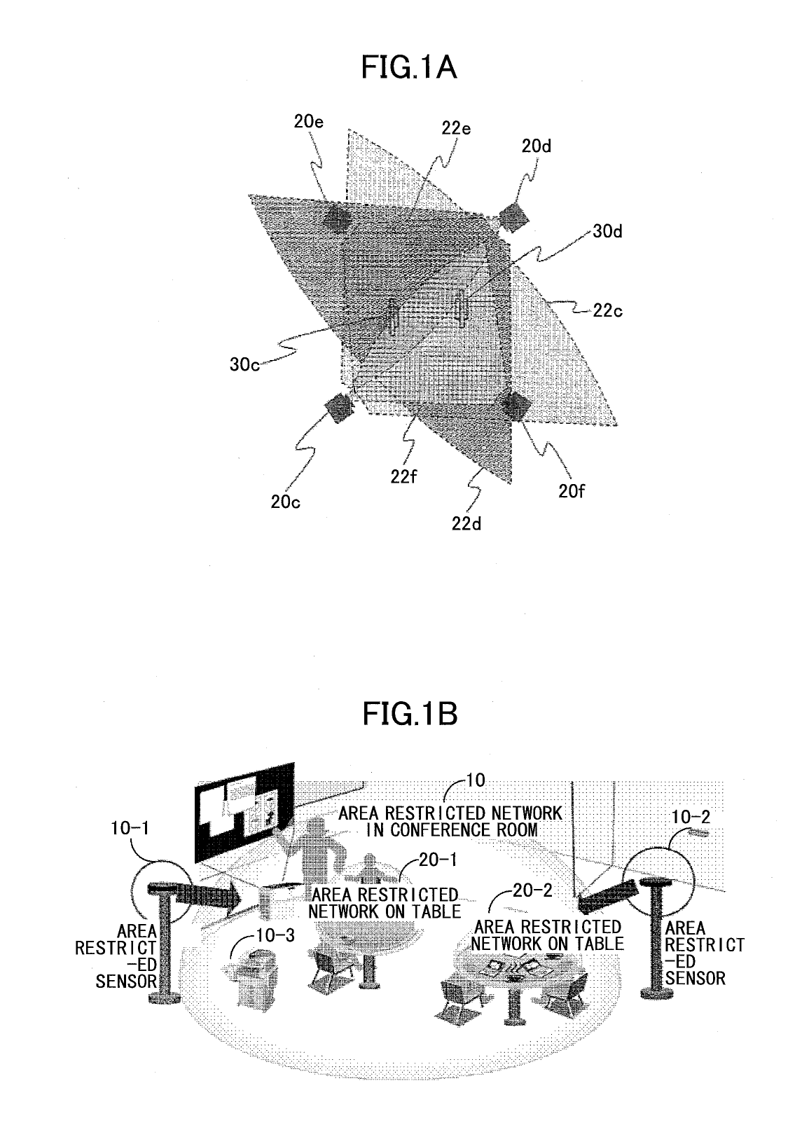

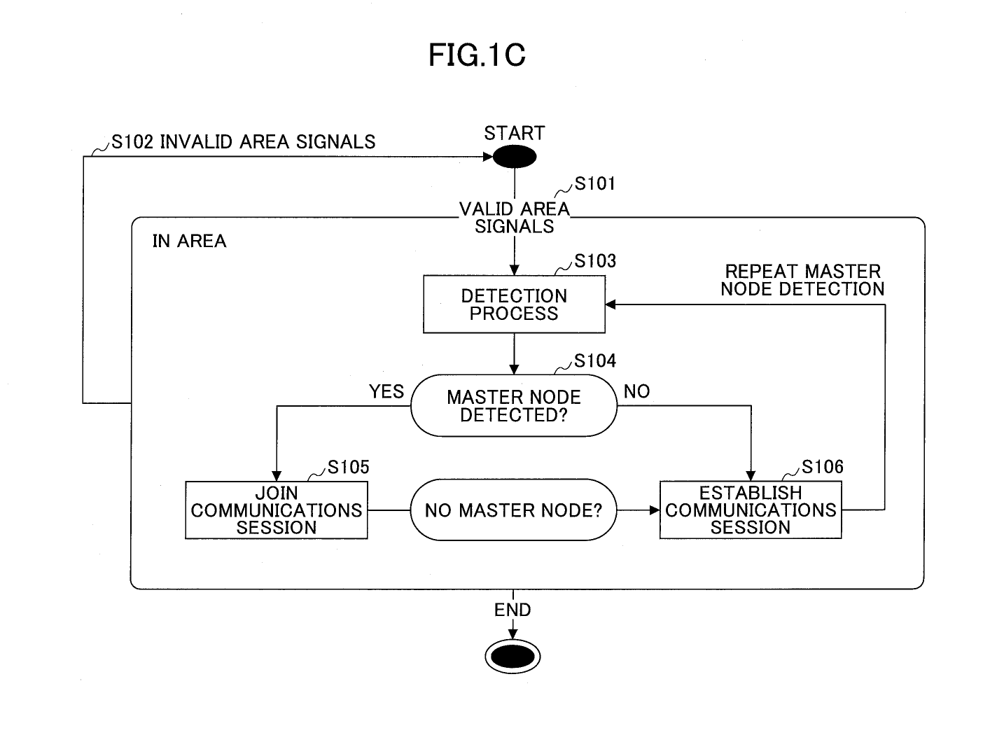

FIG. 1A illustrates a concept of an area restricted network.

As shown in FIG. 1A, an area restricted network is limited by utilizing four signal transmitters 20c, 20d, 20e, and 20f. Each of the four signal transmitters transmits signals to a certain range, and the area restricted network is formed by the intersection of the four certain ranges. In addition, authorized devices in the area restricted network are capable of communicating with each other in any wireless communications way, and the authorized devices in the area restricted network are not capable of communicating with an unauthorized device in the area restricted network or a device located outside of the area restricted network. For example, in FIG. 1A, in a case where there are two authorized devices 30c and 30d in the area restricted network, they are capable of communicating with each other, but are not capable of communicating with a device located outside of the area restricted network.

That is to say, an area restricted network is a physical layer based concept. The concept of the area restricted network is different from a conventional one on the basis of the wireless fidelity (WiFi or caller “802.11b standard”) or any other wireless communications network. The boundary of the area restricted network is clearer than that of any conventional wireless communications network. The reason is that the area restricted network is limited by, for example, plural signal transmitters having good directionality, located in a physical layer. In addition, the area restricted network is easily established. The reason is that it is possible to arbitrarily select positions for setting, for example, the signal transmitters. As a result, this kind of area restricted network may play an important role in a complicated office environment.

Moreover, the so-called “area key (AK)” in this specification is used to uniquely limit a restricted area. The area key may be transmitted by an area key transmitter. The area key transmitter may be, for example, an IR transmitter, a LED transmitter, or a microwave transmitter. The area key may be carried by, for example, an infrared ray, a light beam, or a microwave. The area key may include but is not limited to an area identifier (ID), a random secret key, a time stamp, and/or other information. The area ID included in the area key may be used to uniquely indicate a restricted area. Aside from indicating a restricted area, the area key is also for carrying out encryption so as to achieve reliable communications. The area key may be predetermined and fixed, and may be changed periodically so as to achieve more reliable communications.

In an office environment, for example, in a conference room, in an isolated region, and on a desktop, plural area restricted networks (for example, wireless ad hoc networks) located in different physical layers may exist simultaneously. The meaning of the different physical layers may be that the coverage of an area restricted network located in a predetermined physical layer includes an area restricted network located in a physical layer lower than the predetermined physical layer.

FIG. 1B illustrates an application environment of a hierarchical area restricted network.

As shown in FIG. 1B, in a conference room, there is an area restricted network 10, and its area is limited by, for example, two IR transmitters 10-1 and 10-2 which are located in two diagonal corners of the conference room, respectively. Furthermore, in the area restricted network 10 of the conference room (for example, in an area determined by the intersection of the coverages of the IR transmitter 10-1 and 10-2), there are also two area restricted networks 20-1 and 20-2 respectively being on two tables in the conference room, and the area of each of the two area restricted networks 20-1 and 20-2 is limited by two Bluetooth transmitters (not shown in the drawing) located in two diagonal corners of the corresponding tables, respectively. In this case, the area restricted network of the conference room may be considered an area restricted network located in a physical layer upper than the physical layer in which the two area restricted networks 20-1 and 20-2 are located, and at the same time, the area restricted networks 20-1 and 20-2 may be considered as two area restricted networks located in a physical layer lower than the physical layer in which the area restricted network 10 is located. In this case, for example, a notebook computer within the area restricted network 20-2 is capable of communicating with another notebook computer within the area restricted network 20-2, and at the same time, the two notebook computers are also located in the area restricted network 10 of the conference room. As a result, in order to accomplish a purpose, it is also necessary to let the two notebook computers located in the area restricted networks 20-2 be able to communicate with a device, for example, a printer 10-3 located in the area restricted network 10.

Therefore, in a case where a hierarchical area restricted network including, for example, the above-described area restricted network 10, 20-1, and 20-2 exists, it is necessary to provide a mechanism by which devices in the area restricted networks located in different layers are capable of communicating with each other.

In addition, prior to illustrating the respective embodiments of the present invention, a process of managing the communications between a master node and a slave node in a single area restricted network is given by referring to FIG. 1C.

Here it should be noted that the so-called “node” in this specification refers to a device, for example, a mobile device such as a cellular phone, a notebook computer, a personal digital assistant (PDA), a tablet computer, a game machine, a printer, a copier, or a projector. Moreover, the so-called “master node” and “slave node” are just named for distinguishing their functions; that is to say, the present invention is not limited to this.

FIG. 1C illustrates a process of managing the communications between a master node and a slave node in a single area restricted network.

In FIG. 1C, it is assumed that signals transmitted by plural signal transmitters for determining the single area restricted network are called “area signals”. If a device (or called a “node”) in the single area restricted network receives valid area signals (for example, a set of signals transmitted by the plural signal transmitters), then it is possible to determine that the device is located in the single area restricted network (STEP S101 in FIG. 1C), and if the device receives invalid area signals (for example, signals transmitted by only one of the plural signal transmitters), then it is possible to continue to receive the area signals until the valid area signals are received (STEP S102 in FIG. 1C). In a case where the device is located in the single area restricted network (i.e., the device has received the valid area signals), a detection process is started for detecting whether a master node exists in the single area restricted network (STEP S103 in FIG. IC). In STEP S104, if it is determined that the master node exists, then STEP S105 is carried out so as to let the device enter an existing communications session managed by the master node. On the other hand, in STEP S104, if it is determined that the master node does not exist (or an existing master node has disappeared), then STEP S106 is carried out so as to let the device be a new master node (or to select another device in the single area restricted network to be a new master node), and to create a communication session managed by the new master node itself.

Here it should be noted that the communications session may cause another device (or called a “slave node”) latterly or simultaneously entering the single area restricted network to join the communication session managed by the master node, i.e., may cause all devices, which have entered the single area restricted network, to be able to communicate with each other. In addition, as for the communications session managed by the master node, the master node may send a unique area key of the single area restricted network to the respective slave nodes so that the respective slave nodes may utilize the unique area key to carry out reliable communications. This kind of area key may be fixed or changed periodically. Furthermore, in general, this kind of communications may adopt a way of utilizing the area key to carry out authorization. In Chinese Patent Application No. 201310056656.0, an example of how to utilize an area key to carry out authorization is disclosed in detail, and the entire contents of this Chinese patent application are hereby incorporated by reference. Of course, it is also possible to adopt another method to utilize an area key to carry out authorization; that is to say, the present invention is not limited to this.

Up to here, how to manage the communications of devices in a single area restricted network has been described. In what follows, the respective embodiments of the present invention will be given by referring to the related drawings.

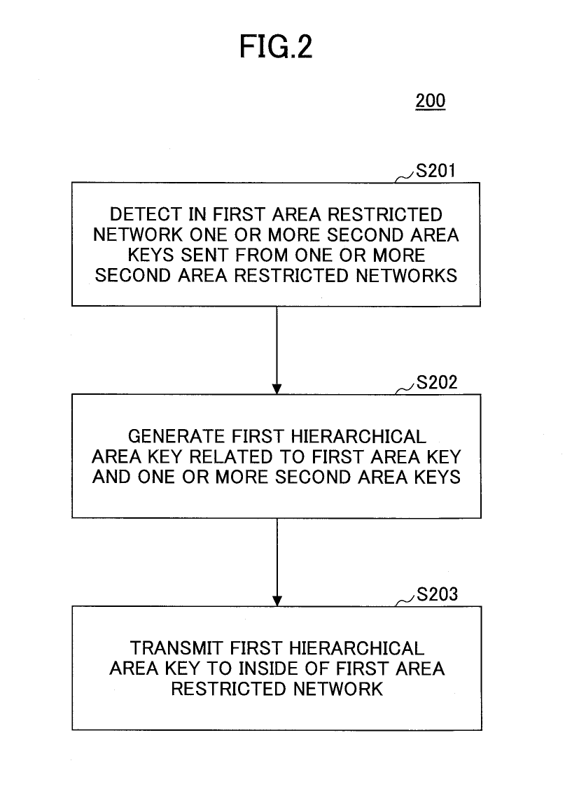

FIG. 2 is a flowchart of an area restricted network management method 200 according to an embodiment of the present invention.

As shown in FIG. 2, the area restricted network management method 200 includes STEP S201, STEP S202, and STEP S203. STEP S201 is for detecting, in a first area restricted network, one or more second area keys sent from one or more second area restricted networks. STEP S202 is for generating a first hierarchical area key which is related to a first area key generated by the first restricted network as well as at least one of the detected one or more second area keys. STEP S203 is for transmitting the first hierarchical area key to the inside of the first area restricted network.

In general, in an area restricted network, there may be plural signal transmitters by which the area restricted network may be determined. In addition, in the area restricted network, there is also an area key generator that is capable of generating an area key of the area restricted network itself on the basis of the respective signals transmitted by the signal transmitters. For more information about how to generate the area key, for example, it is possible to refer to the above-mentioned Chinese Patent Application No. 201310056656.0. Here it should be noted that of course, aside from the respective signals transmitted by the signal transmitters, the area key may also be generated on the basis of other information by utilizing a conventional area key generation method; that is to say, the present invention is not limited to this.

Moreover, in general, in a case where there is only a single area restricted network, an area key generator in the single area restricted network is capable of generating an area key of the single area restricted network itself, and is capable of transmitting the generated area key to devices located in the single area restricted network so as to let the devices communicate with each other.

However, in a case where a hierarchical area restricted network exists, for example, in a case where one or more second area restricted networks include the above-mentioned first area restricted network, a hierarchical area key generator (that is a device used to generate a hierarchical area key, and may have other names) in the first area restricted network may detect one or more second area keys transmitted from the one or more second area restricted networks (STEP S201).

After that, in STEP S202, the hierarchical area key generator may generate a first hierarchical area key which is related to a first area key generated by the area key generator in the first area restricted network as well as at least one of the detected one or more second area keys. As described above, the area key generator in the first area restricted network is capable of generating a first area key of the first area restricted network, and the generated first area key does not include information of the one or more second area restricted networks covering the first area restricted network. In other words, only by the first area key, it is impossible to know in which second area restricted network(s) the first area restricted network is located. On the other hand, in STEP S202, the first hierarchical area key is generated which is related to the first area key of the first area restricted network itself as well as at least one of the generated one or more second area keys. In this way, the first hierarchical area key may include the information of the one or more second area restricted networks covering the first area restricted network, so that a device, which has received the first hierarchical area key, in the first area restricted network may determine, by analyzing the first hierarchical area key, by which second area network(s) the device itself is covered. That is to say, it is possible to obtain the topological structure of a hierarchical area restricted network.

After that, in STEP S203, it is possible to transmit, by the first hierarchical area key generator, the first hierarchical area key to the inside of the first area restricted network. In this way, various devices (a master node and one or more slave nodes) within the first area restricted network may communicate with each other by utilizing the first hierarchical area key. At the same time, since the first hierarchical area key also includes the information of the one or more second area restricted area networks, when a device in the first area restricted network wants to communicate with another device in a second area restricted network covering the first area restricted network, the device in the first area restricted network may utilize the first hierarchical area key or the detected second area key of the second area restricted network to communicate with the other device within the second area restricted network.

In a case where the device in the first area restricted network utilizes the detected second area key of the second area restricted network to communicate with the other device in the second area restricted network, only by utilizing the detected second area key, it is possible to communicate with the other device within the second area restricted network. The reason is that the other device in the second area restricted network has known the second area key. In addition, the device in the first area restricted network may utilize the received first hierarchical area key to communicate with the other device in the second area restricted network. In this case, when the device receives the first hierarchical area key from the first area restricted network, it is also possible to grasp, by analyzing the first hierarchical area key, by which second area restricted network(s) the device in the first area restricted network is covered. For example, it is possible to obtain the second area key of the second area restricted network by analyzing the first hierarchical area key. As a result, it is possible to authorize the device within the first area restricted network to communicate with the other device in the second area restricted network.

In addition, as described above, in the first area restricted network, a device in the first area restricted network may utilize the received first hierarchical area key to communicate with another device in the first area restricted network.

That is to say, the method 200 may further include a step of utilizing the first hierarchical area key to carry out authorization with respect to an authorized device newly entering the first area restricted network. As described above, in a single area restricted network, a master node may perform authorization on an unauthorized device newly entering the single area restricted network. Similarly, in the first area restricted network within the hierarchical area restricted network, it is also possible to conduct authorization with respect to an unauthorized device in the first area restricted network. For more information about this kind of authorization, for example, it is possible to refer to the above-mentioned Chinese Patent Application No. 201310056656.0. Here it should be noted that of course, it is also possible to adopt a conventional method to carry out this kind of authorization. In others words, as long as the above-described area key is utilized, any authorization method may be adopted in the present invention.

In an example, the first area key generated by the first area restricted network may be related to an identifier (ID) of the first area restricted network as well as an area security key used in the first area restricted network for carrying out communications.

In an example, the first hierarchical area key may be a set of the first area key and at least one of the detected one or more second area keys.

In an example, the detected one or more second area keys may be one or more second hierarchical area keys. That is to say, the one or more second area restricted networks may be located in one or more third area restricted networks. As a result, in this case, the one or more second area keys (i.e., the one or more second hierarchical area keys) may be second hierarchical area keys which are related to one or more third area keys sent from the one or more third area restricted networks as well as one or more second area keys generated by the one or more second area restricted networks themselves.

In this case, at least one of the detected one or more second area keys may be a second hierarchical area key of a second area restricted network located in the upper layer of the first area restricted network. That is to say, in a case where the detected one or more second area keys may be one or more second hierarchical area keys, STEP S201 may further include a step (not shown in the drawings) of determining which second area key of the detected one or more second area keys is one sent from the area restricted network located in the upper layer of the first area restricted network. As described above, since the first and second hierarchical area keys include the information of one or more area restricted networks covering the first and second area restricted networks, it is possible to obtain, according to these kinds of hierarchical area keys, the topological structure of the hierarchical area restricted network. As a result, it is possible to know which second area key of the detected one or more second area keys is one sent from the area restricted network located in the upper layer of the first area restricted network.

In this case, STEP S202 may include a step (not shown in the drawings) of generating a first hierarchical area key which is related to a second area key, that is determined as sent from an area restricted network located in the upper layer of the first area restricted network, as well as a first area key generated by the first area restricted network. For example, if there are three area restricted networks in a hierarchical area restricted network, then the three area restricted networks are located in three layers, respectively. For example, if a first area restricted network is located in the bottom layer, a second area restricted network is located in the middle layer (the second area restricted network covers the first area restricted network), and another second area restricted network is located in the top layer (the other second area restricted network covers the first and second area restricted networks), then the first area restricted network may detect a hierarchical area key (including information of the other second area restricted network covering the second area restricted network) sent from the second area restricted network as well as area keys respectively sent from the second area restricted network and the other second area restricted network. As a result, by analyzing the detected respective area keys, it is possible to obtain the topological structure of the hierarchical area restricted network, i.e., it is possible to grasp that the first area restricted network is located in the bottom layer, the second area restricted network is located in the middle layer, and the other second area restricted network is located in the top layer. Hence, it is easy to know that the second area restricted network is an area restricted network located in the upper layer of the first area restricted network. As a result, in this step (not shown in the drawings), a first hierarchical area key is generated which is related to a second area key (sometimes a hierarchical area key), that is determined as sent from an area restricted network located in the upper layer of the first area restricted network, as well as a first area key generated by the first area restricted network itself.

In an example, the step, of determining which one of the one or more second area keys is one sent from an area restricted network located in the upper layer of the first area restricted network, may include a step of selecting one, whose number of related area keys is maximum (i.e., which has a maximum number of related area keys), from the one or more second area keys, and letting the selected one serve as the second area key sent from the area restricted network located in the upper layer of the first area restricted network. The reason is that as described above, in an example, the first hierarchical area key may be a set of at least one of the detected one or more second area keys and the first area key. Similarly, the second hierarchical area key may also be a set of at least one of the detected or one or more third area keys and the second area key (here, the one or more third area keys are transmitted from an area restricted network located in the upper layer of the second area restricted network). That is to say, the hierarchical area key of each area restricted network may be generated in this way. As a result, according to the number of related area keys in the set of the corresponding hierarchical area key, it is possible to determine in which layer the corresponding area restricted network is located. For example, if the number of the related area keys in the set of the corresponding hierarchical area key is two, then it is possible to determine that the corresponding area restricted network is located in a second layer from the top layer in which a root area restricted network is located. The reason is that one of the two area keys is sent from the root area restricted network, and another is generated by the current area restricted network itself. Again, for example, if the number of the related area keys in the set of the corresponding hierarchical area key is three, then it is possible to determine that the corresponding area restricted network is located in a third layer from the top layer. The reason is that among the three area keys, one is sent from the root area restricted network, one is generated by the area restricted network located in the second layer, and one is generated by the current area restricted network itself. Here it should be noted that of course, the step, of determining which one of the one or more second area keys is one sent from an area restricted network located in the upper layer of the first area restricted network, may also be achieved by adopting another method. The reason is that these kinds of second (hierarchical) area keys include information of the corresponding hierarchical area restricted network. As a result, it is possible to find a method by which this kind of hierarchical information can be extracted, so that it is possible to determine which is an upper layer of the current layer in which the first area restricted network is located.

In this way, by generating a hierarchical area key including information of one or more area restricted networks covering a current area restricted network, it is possible to inform a device, which has received the hierarchical area key, of the topological structure of the corresponding hierarchical area network, so that the device may communicate with another device in the current area restricted network or one or more devices in the one or more area restricted networks covering the current area restricted network. For example, as shown in FIG. 1B, a notebook computer located in the area restricted network 20-2 may communicate with another notebook computer located in the same area restricted network 20-2. Furthermore, since the two notebook computers are also located in the area restricted network 20, according to the embodiments of the present invention, the two notebook computers may also communicate with the printer 10-3 located in the area restricted network 10.

As a result, according to the embodiments of the present invention, in a case where a hierarchical area restricted network exists, it is possible to ensure that devices within the respective area restricted networks of the hierarchical area restricted network may communicate with each other, and it is also possible to achieve reliable communications in the hierarchical area restricted network.

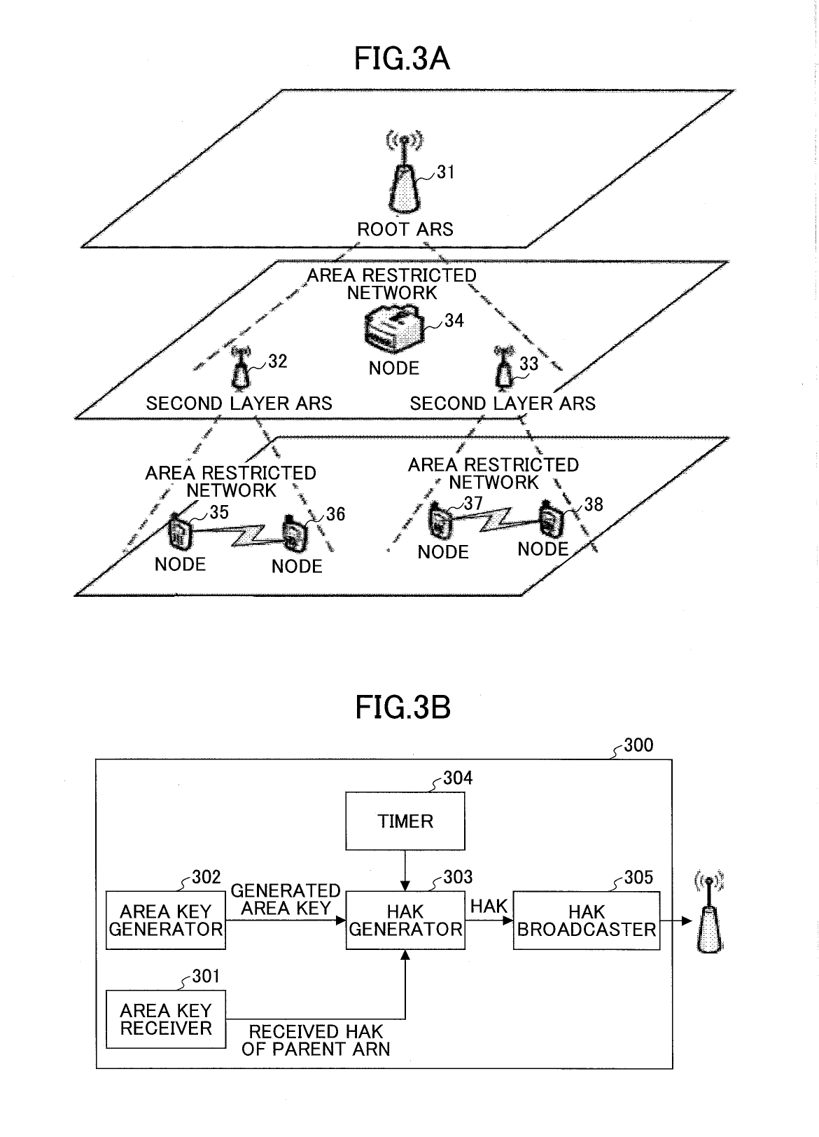

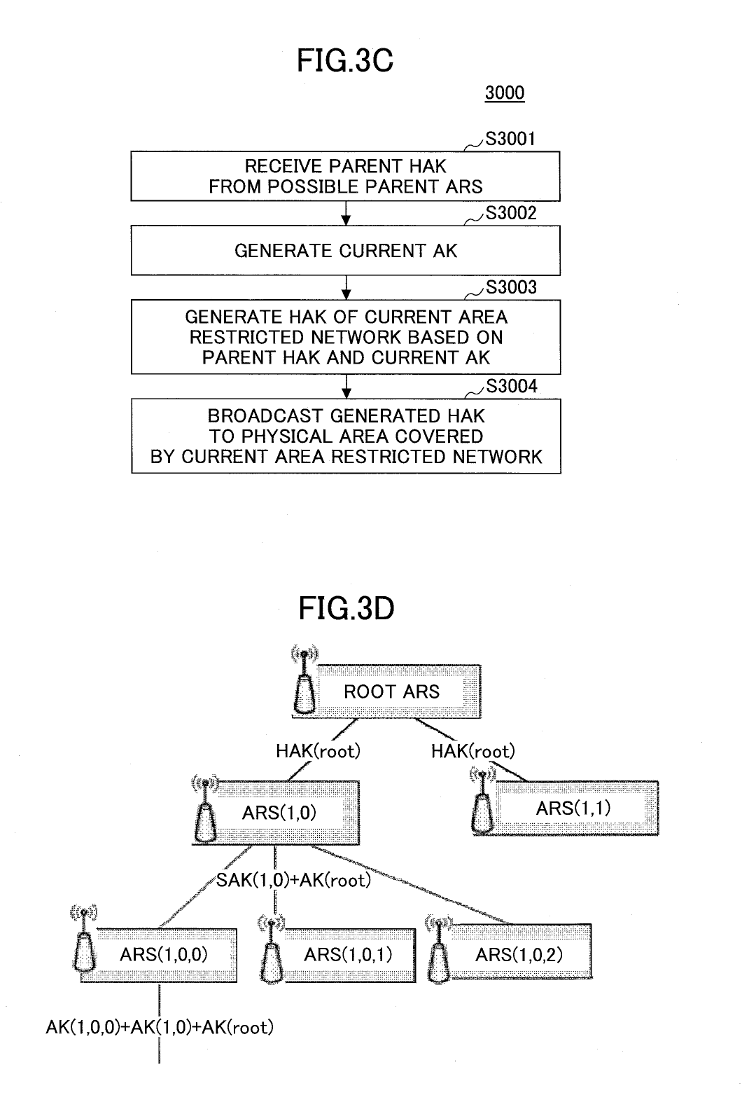

FIGS. 3A to 3D illustrate a hierarchical area key passing method used in a hierarchical area restricted network according to an embodiment of the present invention.

FIG. 3A illustrates a hierarchical area restricted network in which there are two layers, i.e., a top layer (or called a “root”) and a second layer that is lower than the top layer.

As shown in FIG. 3A, an area restricted sensor (ARS, or called a “root ARS”; for example, including the hierarchical area key generator and the area key generator illustrated on the basis of FIG. 2) 31 in an area restricted network (ARN, or called a “root ARN”; for example, the area restricted network 10 shown in FIG. 1B) located in the top layer broadcasts its own area key to the root area restricted network and second-layer area restricted networks (or called “second-layer ARNs”) located in the second layer. Here it should be noted that since there isn't an area restricted network covering the root area restricted network, the root area restricted network does not need to generate a hierarchical area key. That is to say, the root area restricted network only needs to generate its own area key by utilizing, for example, the area key generator illustrated on the basis of FIG. 2. In addition, the root area restricted network physically covers a printer node 34 and two second-layer area restricted networks (for example, the area restricted networks 20-1 and 20-2 shown in FIG. 1B). After that, each of second-layer area restricted sensors (or called “second-layer ARSs”) 32 and 34 transmits a hierarchical area key, which is related to the area key of the root area restricted network and an area key of the corresponding second-layer area restricted network, to nodes located in the corresponding second-layer area restricted network. As shown in FIG. 3A, in one second-layer area restricted network, there are two nodes 35 and 36, and in anther second-layer area restricted network, there are two nodes 37 and 38. Here it should be noted that an area restricted network, for example, the root area restricted network located in the upper layer of a current area restricted network, for example, each of the second-layer area restricted networks may be called a parent area restricted network of the current area restricted network; at the same time, the current area restricted network may be called a child area restricted network of the parent area restricted network.

FIG. 3B is a block diagram of an area restricted sensor (ARS) 300 within an area restricted network.

As shown in FIG. 3B, the area restricted sensor 300 may include an area key receiver 301, an area key generator 302, a hierarchical area key generator (HAK generator) 303, a timer 304, and a hierarchical area key broadcaster (HAK broadcaster) 305. The area key receiver 301 is configured to receive an area key or hierarchical area key from an area restricted sensor within a parent area restricted network. The area key generator 302 is configured to generate an area key of the area restricted network itself. The HAK generator 303 is configured to generate a hierarchical area key which is related to, for example, the received area key or hierarchical area key as well as the generated area key of the area restricted network itself. The timer 340 is optional, and may be configured to synchronize the two inputs (for example, the received area key or hierarchical area key as well as the generated area key of the area restricted network itself) to a predetermined time window. The HAK broadcaster 305 is configured to broadcast the generated hierarchical area key to one or more nodes, devices, or child area restricted networks physically covered by the area restricted network.

In an example, the HAK generator 303 may simply combine the received area key or hierarchical area key with the generated area key to generate a hierarchical area key. For example, it is possible to generate a set including the received area key or hierarchical area key and the generated area key in this order, so as to serve as the generated hierarchical area key. In other words, as long as it is possible to obtain the received area key or hierarchical area key as well as the generated area key of the area restricted area itself by analyzing the generated hierarchical area key, it is possible to adopt any method to obtain the generated hierarchical area key.

FIG. 3C is a flowchart of a method 3000 of passing a hierarchical area key.

As shown in FIG. 3C, the method 3000 includes STEP S3001, STEP S3002, STEP S3003, and STEP S3004. STEP S3001 is for receiving, by an area restricted sensor in a current restricted network, a hierarchical area key from a possible parent area restricted sensor located in its upper layer. Here it should be noted that what the area restricted sensor receives is a hierarchical area key, but is not an area key. The reason is that it is assumed that there is an area restricted network located in the upper layer of the parent area restricted network. As a result, it is supposed that the possible parent area restricted sensor has generated and broadcasted the hierarchical area key. STEP S3002 is for generating, by the area restricted sensor, its own area key. STEP S3003 is for generating, by the area restricted sensor, a hierarchical area key of the current area restricted network on the basis of the hierarchical area key received from the possible parent area restricted sensor and the area key generated for itself. STEP S3004 is for broadcasting, by the area restricted sensor, the generated hierarchical area key to a physical area covered by the current area restricted network. The physical area may include one or more devices or possible child area restricted networks.

FIG. 3D illustrates an example of passing an area key or hierarchical area key according to the method 3000 shown in FIG. 3C.

As shown in FIG. 3D, in STEP S3001, an area restricted sensor (ARS (1,0) or ARS (1,1)) in a current area restricted network i receives a hierarchical area key HAKᵢ₋₁ from a possible root area restricted network (Root ARS) located in its upper layer. Here, HAKᵢ₋₁={AKᵣₒₒₜ, AK₁, . . . , AKₖ, . . . , Akᵢ₋₁}.

That is to say, the received HAKᵢ₋₁ is a set of the area key AKᵣₒₒₜ generated by the possible root area restricted network and the area keys AK₁, . . . , AKₖ, . . . , Akᵢ₋₁ sent from other area restricted networks 1, . . . , k, . . . , i−1 to the possible root area restricted network.

In STEP S3002, the area restricted sensor generates its own area key Aki.

In an instance, Akᵢ=(AIDᵢ,ASKᵢ(T_{window}))

Here, AIDᵢ refers to a unique ID of the current area restricted network i in which the area restricted sensor is located. ASKᵢ (T_{window}) refers to an area security key of the current area restricted network i within the time window of a time point T_{window}, and may be unique within the time window. In other words, for the sake of security, ASKᵢ(T_{window}) may change in different time windows, i.e., may change according to time. Here it should be noted that it is possible to adopt any conventional method to generate ASKᵢ(T_{window}); that is to say, the present invention is not limited to this. In addition, in a case where there is only one single area restricted network, nodes in the single area restricted network have been able to utilize the generated ASKᵢ (T_{window}) for carrying out authorization, data encryption, reliable communications, and so on.

In STEP S3003, it is possible to use the received parent HAKᵢ₋₁ and the generated AKᵢ to generate a hierarchical area key HAKᵢ₋₁ for the current area restricted network in which the area restricted sensor is located.

In an instance,

HAKᵢ=HAKᵢ₋₁⊚{AKᵢ}={AKᵣₒₒₜ,AK₁, . . . ,AKₖ, . . . ,AKᵢ₋₁,AKᵢ}.

That is to say, in this instance, HAKᵢ is a set obtained by inserting the generated AKᵢ after AKᵢ₋₁ in the received HAKᵢ₋₁.

Of course, it is also possible to adopt another method for generating the hierarchical area key HAKᵢ. For example, in another instance, at a time point T, the received parent HAKᵢ₋₁ may be a string “001A0EFDCE00”, wherein, “001A” refers to an ID of the possible parent area restricted network, and “0EFDCE00” refers to an area security key of the possible parent area restricted network at the time point T; and the generated AKᵢ may be a string “001B878CCDEE”, wherein, “001B” refers to the ID of the current area restricted network i, and “878CCDEE” refers to an area security key of the current area restricted network i at the time point T. In this case, an example of the combination of the two may be MergedKey=“001A0EFDCE00#001B878CCDEE”, wherein, “#” refers to a predetermined separator. Of course, those people skilled in the art may adopt any conventional method to combine the two; that is to say, the present invention is not limited to this.

In STEP S3004, it is possible to broadcast the generated HAKᵢ to the inside of a physical area covered by the current area restricted network i. This physical area may include one or more devices or possible child area restricted networks.

Moreover, in order to establish a hierarchical area restricted network, it is possible to define the following rules. However, it should be noted that the present invention is not limited to this.

(1) Each area restricted network is capable of receiving an area key or hierarchical area key (if it exists) from another area restricted network, generating its own area key, and broadcasting a hierarchical area key generated by itself to a physical area covered by itself by using, for example, wireless signals of itself. The respective area restricted networks are located in layers of the hierarchical area restricted network. It should be noted that in which layer an area restricted work is located is determined by the signal receiving ability of an area restricted sensor in the area restricted work as well as the signal coverage size of signal transmitters for defining the area restricted network.

(2) Any two area restricted networks located in a same layer of the hierarchical area restricted network do not have an overlap zone. In a case where there is an overlap zone, it is possible to prescribe in advance one of the two area restricted networks to manage the overlap zone. In this way, it is possible to avoid collision.

(3) The maximum number of child area restricted networks of each area restricted network may be determined on the basis of the signal coverage size of the corresponding area restricted network divided by the signal coverage size of one child area restricted network. Of course, actually, the maximum number of child area restricted networks of each area restricted network may also relate to, for example, signal coverage strength and attenuation.

As a result, it is possible to grasp in which layer of the hierarchical area restricted network each area restricted network is located.

In particular, in an example, it is possible to adopt the following equation to know, by analyzing the hierarchical area key HAKᵢ of the current area restricted network i, a position (a layer) POSᵢ in which the current area restricted network i is located.

POSᵢ=POS(HAKᵢ)=|HAKⱼ|

Here, |*| refers to the number of elements of the set corresponding to the hierarchical area key HAKᵢ. That is to say, as described above, the hierarchical area key HAKᵢ of the current area restricted network i is made by inserting the generated AKᵢ after the last element of the received HAKᵢ₋₁. As a result, it is possible to determine, on the basis of the number of elements of the set corresponding to HAKᵢ, in which layer of the hierarchical area restricted network the current area restricted network i is located. Of course, the present invention is not limited to this. For example, in a case where the hierarchical area key HAKᵢ is generated by using another method, it is also possible to adopt another approach based the other method to determine in which layer of the hierarchical area restricted network the current area restricted network i is located.

The area security key ASKⱼ of a parent area restricted network j may be obtained by utilizing the following equation.

ASKⱼ=f(HAKᵢ),root≦j≦i

That is to say, it is possible to analyze the hierarchical area key HAKᵢ of the current area restricted network i so as to acquire the area security key ASKⱼ of the parent area restricted network j of the current area restricted network i. The reason is that the hierarchical area key HAKᵢ of the current area restricted network i has included information of the area key AKⱼ (or the hierarchical area key HAKⱼ) of the parent area restricted network j, and the area key AKⱼ (or the hierarchical area key HAKⱼ) has contained the area security key ASKⱼ of the parent area network j itself as described above, i.e., AKᵢ=(AIDᵢ,ASKᵢ(T_{window})). In other words, as long as the hierarchical area key HAKᵢ of the current area restricted network i is received, it is possible to know in which layer the parent area restricted network j of the current area restricted network i is located, and to know what the area security key ASKⱼ of the parent area restricted network is. In this way, a node in the current area restricted network i may communicate with each node in the parent area restricted network j by utilizing the hierarchical area key HAKᵢ of the current area restricted network i.

As a result, in a case where there is a hierarchical area restricted network, it is possible to ensure that devices in the respective layers of the hierarchical area restricted network are able to normally and safely (reliably) communicate with each other.

On the other hand, in a case where a hierarchical area key of each current area restricted network is not generated on the basis of its parent area key or hierarchical area key as well as an area key of the corresponding area restricted network itself, each area restricted network only broadcasts its own area key. In this case, devices within the corresponding area restricted network and within an area restricted network located in the lower layer of the corresponding area restricted network may receive the same area key of the corresponding area restricted network itself. In this case, the devices within the area restricted network located in the lower layer of the corresponding area restricted network do not know that they are also within the corresponding area restricted network located in their upper layer. As a result, the devices in the area restricted network located in the lower layer of the corresponding area restricted network may directly ignore the received area key, or may regard that the received area key is an invalid one, as described above, thereby not being able to communicate with each device in the corresponding area restricted network located in their upper layer. However, according to the area restricted network management method described in the embodiments of the present invention, although in a case where there is a hierarchical area restricted network, it is possible to guarantee that devices in the respective layers of the hierarchical area restricted network are able to normally and safely communicate with each other.

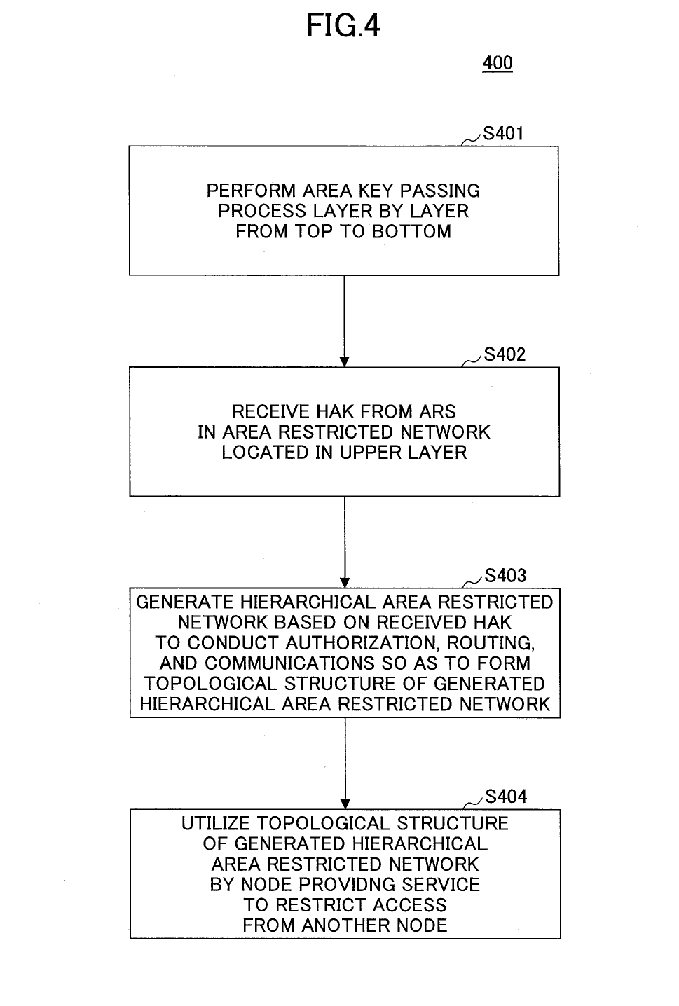

FIG. 4 is a flowchart of a method 400 of establishing a hierarchical area restricted network according to an embodiment of the present invention.

As shown in FIG. 4, the method 400, of establishing a hierarchical area restricted network on the basis of each area restricted sensor and its area restricted attribute, includes STEP S401, STEP S402, STEP S403, and STEP S404. In STEP S401, an area key passing process is carried out layer by layer from top to bottom. That is to say, the area key passing process is carried out with respect to any two adjacent layers (here it should be noted that two adjacent layers refer to an upper layer and a layer just below the upper layer, and the area key passing process is carried out from the upper layer to the layer just below the upper layer) by utilizing area restricted sensors respectively located in the two adjacent layers. In STEP S402, each node in each layer receives a hierarchical area key from an area restricted sensor within an area restricted network located in its upper layer. In STEP S403, each node in each layer forms an area restricted network group (i.e., a hierarchical area restricted network) on the basis of the received hierarchical area key so as to carry out authorization, routing, communications, and so on, thereby forming a topological structure of the hierarchical area restricted network. In STEP S404, each node providing a service to other authorized nodes utilizes this kind of topological structure of the hierarchical area restricted network to restrict (permit or deny) access from a node. For example, as shown in FIG. 1B, in the area restricted network 10, the printer node 10-3 only allows a node located in the same area restricted network 10 or located in its child area restricted networks 20-1 or 20-2 to access its printing service, and does not allow a node located outside of the area restricted network 10 to access its printing service.

Here it should be noted that the process of STEP S401 may be achieved by adopting the method illustrated on the basis of FIG. 2 or FIGS. 3A to 3D. That is to say, each area restricted sensor receives its parent area key (or parent hierarchical area key) so as to generate its own area key, then to generate its own hierarchical area key by using its parent area key (or parent hierarchical area key) and its own area key, and then to broadcast its own hierarchical area key to its own coverage.

As a result, by generating and broadcasting a hierarchical area key, it is possible to let a node that has received the hierarchical area key know the topological structure of the corresponding hierarchical area restricted network, so as to carry out, on the basis of the topological structure of the corresponding hierarchical area restricted network, authorization, routing, communications, and so on. Hence, according to the embodiments of the present invention, in a case where this kind of hierarchical area restricted network exists, it is possible to guarantee that devices in the respective layers may normally and safely communicate with each other.

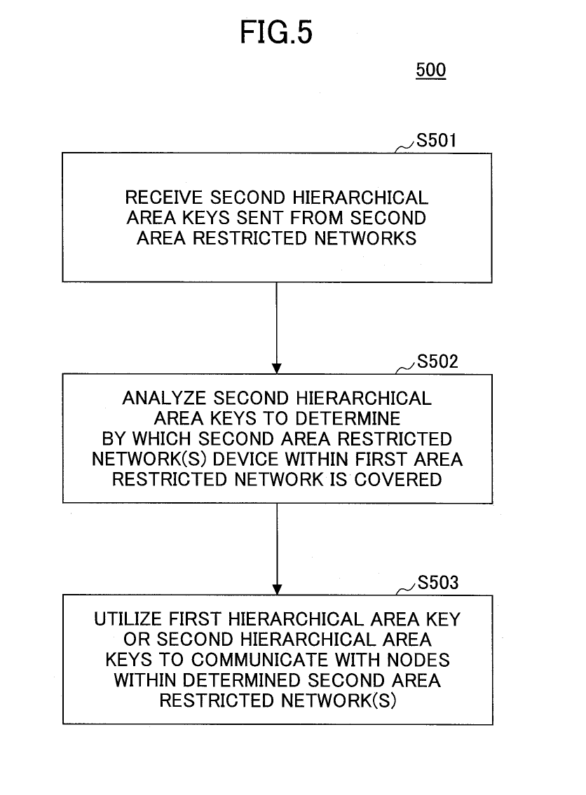

FIG. 5 is a flowchart of an area key receipt method 500 according to an embodiment of the present invention.

As shown in FIG. 5, the area key receipt method 500 is used in a first area restricted area, and includes STEP S501, STEP S502, and STEP S503. STEP S501 is for receiving one or more second hierarchical area keys sent by one or more second area restricted networks. Here, the one or more second hierarchical area keys are managed by the method illustrated on the basis of FIG. 2. STEP S502 is for analyzing the one or more second hierarchical area keys so as to determine in which second area network(s) a device within the first area restricted network is located. STEP S503 is for utilizing, by the device within the first area restricted network, a first hierarchical area key managed by the method illustrated on the basis of FIG. 2 or the one or more second hierarchical area keys to communicate with devices within the determined second area restricted network(s).

In STEP S503, it is possible to generate, by utilizing the first hierarchical area key or one or more second hierarchical area keys, an area security key for communicating with the devices within the determined area restricted network(s). The reason is that as described above, it is possible to use a first hierarchical area key so as to obtain the area security key ASKⱼ of a parent area restricted network j of a current area restricted network i on the basis of the following equation, and it is also possible to use a second hierarchical area key of a parent area restricted network j of a current area restricted network i so as to obtain the following equation by referring to the above-described equation, i.e., AKᵢ=(AIDᵢ,ASKᵢ (T_{window}))

ASKⱼ=f(HAKᵢ),root≦j≦i

In other words, by analyzing a hierarchical area key HAKᵢ used by a node within a current area restricted network i, it is possible to obtain the area security key ASKⱼ of the parent area restricted network j of the area restricted network i. The reason is that the hierarchical area key HAKᵢ of the current area restricted network i includes information of the area key AKⱼ (or the hierarchical area key HAKⱼ) of the parent area restricted area restricted network j, and the area key AKⱼ (or the hierarchical area key HAK) includes the area security key ASKⱼ of the parent area restricted area restricted network j (see the above-described equation, i.e., AKᵢ=(AIDᵢ,ASKᵢ(T_{window}))). That is to say, as long as the hierarchical area key HAKᵢ of the current area restricted network i is received, it is possible to grasp its parent area restricted network j as well as the area security key ASKⱼ of its parent area restricted network j, so that it is possible to let a node within the current area restricted network i be able to communicate with a node within its parent area restricted network j by using the hierarchical area key HAKᵢ because the two nodes may obtain the same area security key ASKⱼ.

As a result, according to the embodiments of the present invention, in a case where there is a hierarchical area network, it is possible to ensure that devices located in the respective layers may normally and safely communicate with each other.

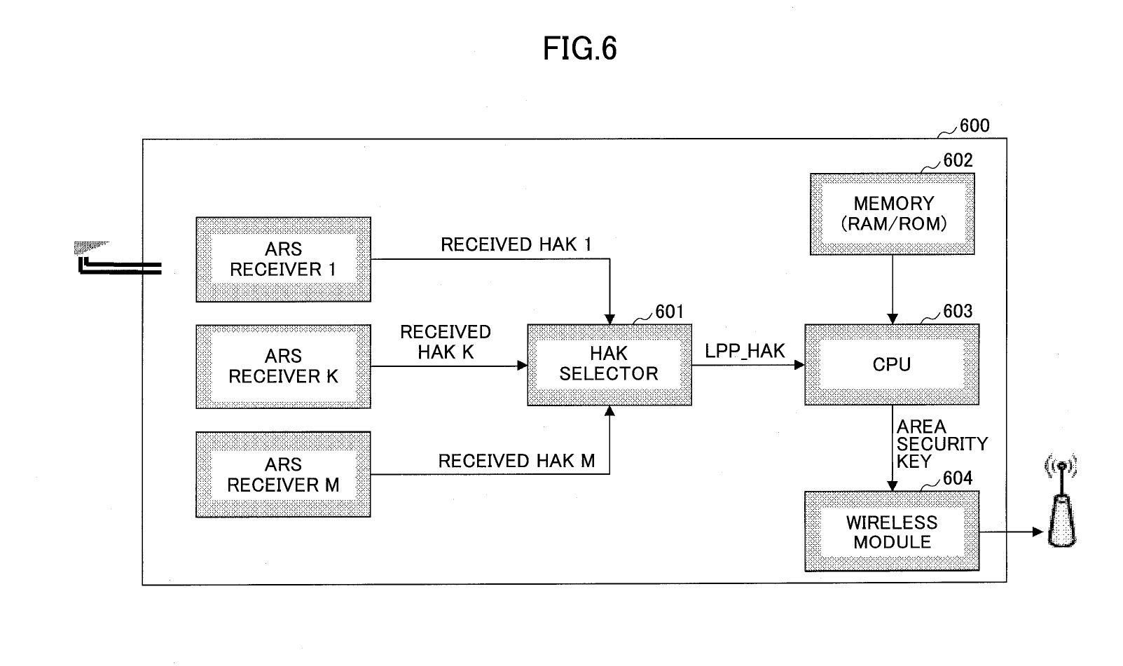

FIG. 6 is a block diagram of an area key receipt node 600 according to an embodiment of the present invention.

As shown in FIG. 6, the node 600 depends on the receipt abilities of its area restricted sensors, and may have one or more area restricted sensors 1, . . . , K, . . . , M for receiving outputs, i.e., hierarchical area keys (or an area key of its root area restricted network; hereinafter, for the sake of convenience, this kind of area key of its root area restricted network is also called a “hierarchical area key”). All the hierarchical area keys received by the node 600 make up a set S as follows.

S={HAK₁, . . . ,HAKₖ},k≧1

The node 600 includes a hierarchical area key selector (HAK selector) 601 which is configured to select, from the set S, a hierarchical area key LPA_HAK of an area restricted network located in the upper layer of the node 600 (i.e., a lowest possible area restricted network of the node 600).

LPA_HAK=f_{LPA}(S)=HAK having max POS(HAK₁), . . . ,POS(HAKₖ)

That is to say, the selected LPA_HAK is a hierarchical area key, whose position (i.e., the number of elements) is maximum, in the set S. The reason is that a hierarchical area key having a maximum position means it is a lowest one among the received hierarchical area keys, i.e., it is the hierarchical area key of an area restricted network nearest the node 600.

After that, the selected LPA_HAK serves as a second hierarchical area key for communicating with devices within a determined second area restricted network as illustrated on the basis of FIG. 5. That is to say, the node 600 uses the selected LPA_HAK to generate an area security key for communicating with the devices within the determined second area restricted network, so as to carry out authorization, routing, communications, and so on.

Of course, the node 600 may also include (but is not limited to) a memory 602 configured to store information; a central processing unit (CPU) 603 configured to conduct calculation; and a wireless module 604 configured to broadcast various area keys and to communicate with other devices.

In what follows, examples of using the selected LPA_HAK to carry out authorization, routing, and communications with devices within the determined second area restricted network will be given.

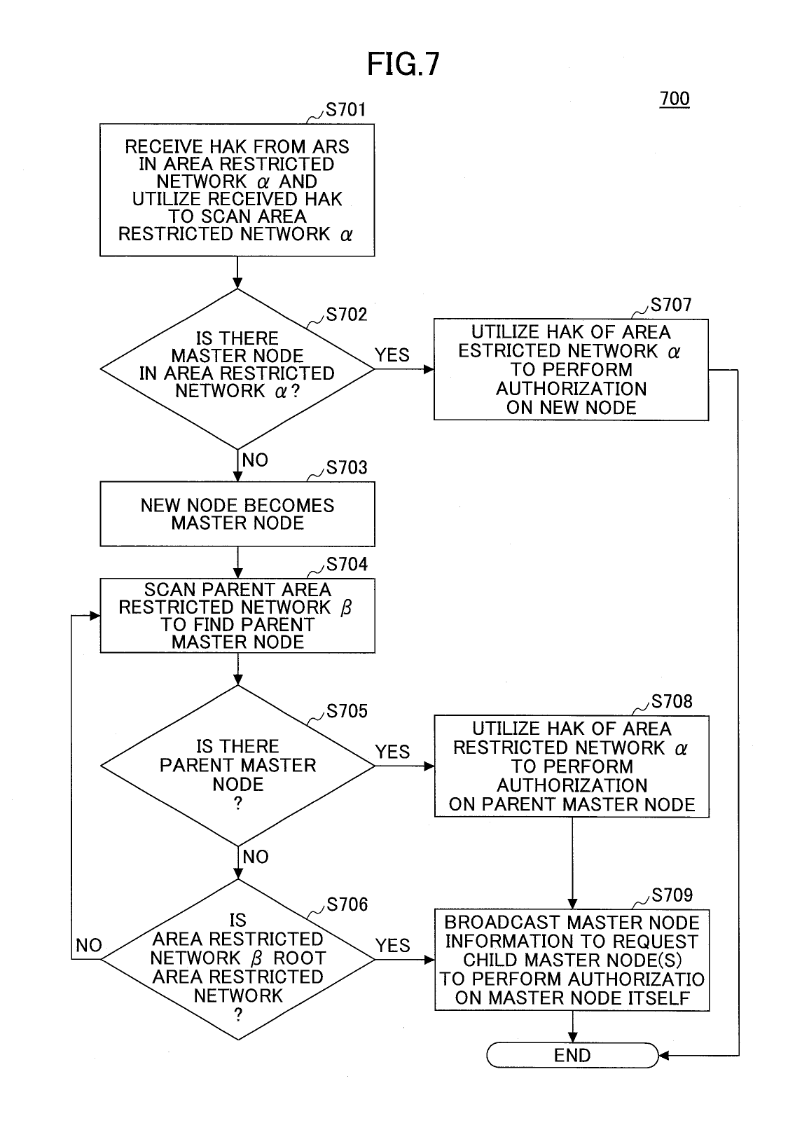

FIG. 7 is a flowchart of a method 700 of performing authorization by utilizing a hierarchical area key obtained according to an embodiment of the present invention.

As shown in FIG. 7, in STEP S701, when a new node enters the physical area of an area restricted network α, the new node detects (receives) a hierarchical area key from an area restricted sensor within the areas restricted network α, and uses the hierarchical area key to scan the area restricted network α.

In STEP S702, it is determined whether there is a master node in the area restricted network α.

If there is the master node in the area restricted network α, STEP S707 is carried out. In STEP S707, the master node uses the hierarchical area key of the area restricted network α to carry out authorization with respect to the new node. An example of the authorization is that the master node requests the hierarchical area key of the new node, and compares the hierarchical area key of the new node and a hierarchical area key received by the master node itself. If the two are the same, the master node authorizes the new node to be a member of the area restricted network α; otherwise, the master node does not authorize the new node to be a member of the area restricted network α. Of course, it is also possible to adopt another authorization method, for example, Wi-Fi protected access (WPA). That is to say, the present invention is not limited to this.

If it is determined that there isn't the master node in the area restricted network α, then STEP S703 is carried out. In STEP S703, the new node becomes the master node.

After the new node becomes the master node (hereinafter, called a “current master node”), in STEP S704, the current master node scans its parent area restricted network β located in its upper layer within the corresponding hierarchical area restricted network, so as to find a master node of its parent area restricted network β. Here it should be noted that the current master node should be located in the coverage of the parent area restricted network β.

In STEP S705, it is determined whether the master node in the parent area restricted network β is found.

If it is determined that the master node in the parent area restricted network β is found, then in STEP S708, the current master node utilizes the hierarchical area key of the area restricted network α to carry out authorization with respect to the master node of the parent area restricted network β.

If it is determined that the master node in the parent area restricted network β is not found, then in STEP S706, the current master node continues to scan an area restricted network located in the upper layer of the parent area restricted network until it is determined that the parent area restricted network β is a root area restricted network.

If it is determined that the parent area restricted network β is the root area restricted network, then STEP S709 is carried out. In STEP S709, the current master node broadcasts its own master information so as to request a master node of its child area restricted network within its coverage to carry out an authorization process with respect to the current master itself (this authorization process is the same as STEP S707).

Here it should be noted that the method 700 shown in FIG. 7 is just an example. That is to say, the present invention is not limited to this. Those people skilled in the art may modify the method 700 or may make a new method on the basis of the hierarchical area key and the topological structure of the corresponding hierarchical area restricted network.

As a result, according to the embodiments of the present invention, in a case where there is a hierarchical area restricted network, it is possible to guarantee that devices in the respective area restricted network may carry out normal authorization and reliable communications.

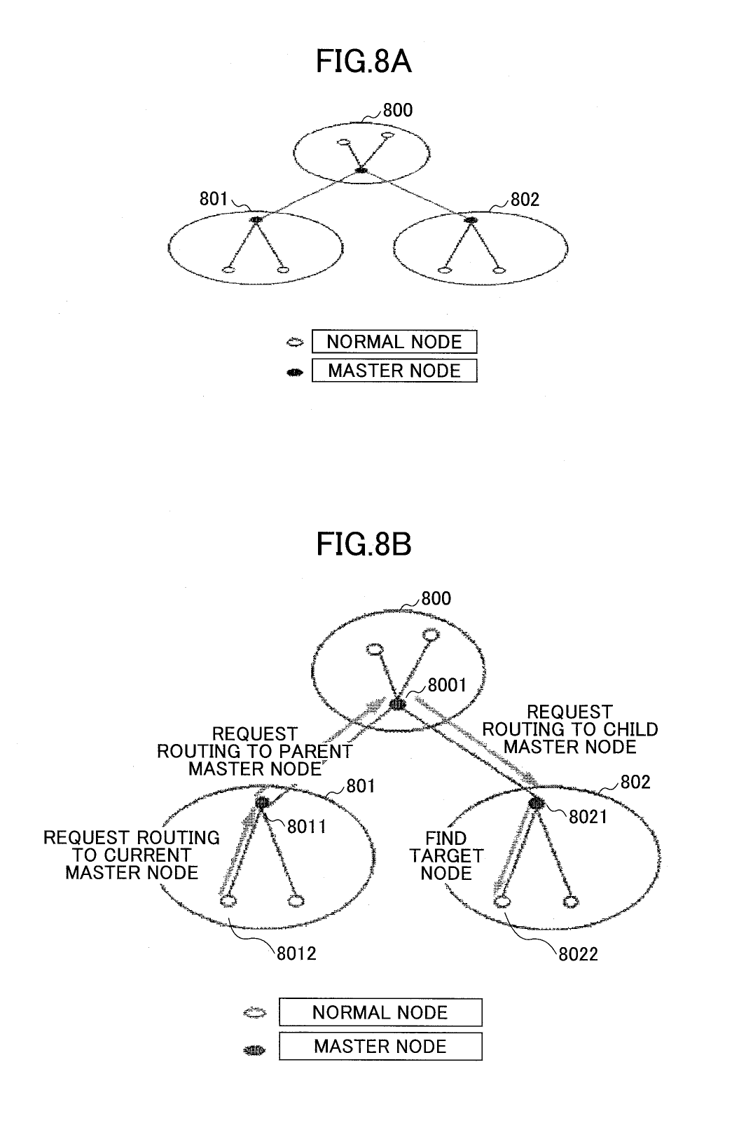

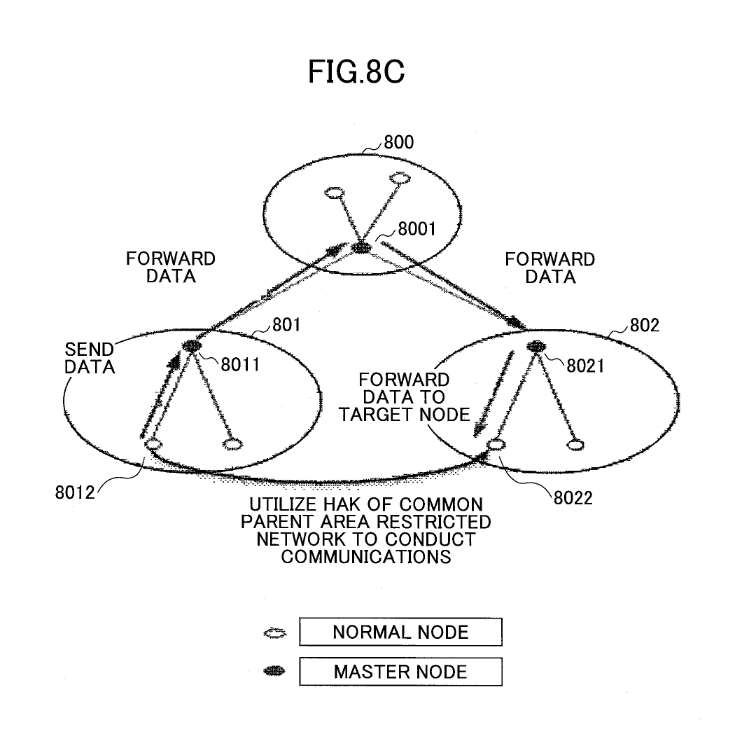

FIGS. 8A to 8C illustrate communications performed on the basis of a hierarchical area key obtained according to an embodiment of the present invention.

FIG. 8A illustrates a hierarchical area restricted network containing two layers. As shown in FIG. 8A, there are three wireless ad hoc networks in the hierarchical area restricted network. In an example, one area restricted network located in the top layer of the hierarchical area network is, for example, an area restricted network 800 in a conference room, and two area restricted networks located in the bottom layer of the hierarchical area network are, for example, two area restricted networks 801 and 802 on two tables in the conference room, respectively. Each of the three area restricted networks has a master node and one or more slave nodes (or called “normal nodes”).

FIG. 8B illustrates a routing method used in the hierarchical area restricted network shown in FIG. 8A. As shown in FIG. 8B, first, each of the master nodes 8001, 8011, and 8021 within the hierarchical area restricted network maintains a routing table. The routing tables include routing information related to the master nodes located in the parent area restricted network and the two child area restricted networks as well routing information relate to the slave nodes located in the respective area restricted networks. Second, a source node 8012 (one of the slave nodes) requests routing information from the master node 8011 within its area restricted network 801. Third, the master node 8011 scans, by utilizing the respective mater nodes located in its parent area restricted network 800 and another child area restricted network 802, the hierarchical area restricted network until a target node, for example, the node 8022 is found. Finally, each master on the determined route updates its own routing table on the basis of information of the determined route.

FIG. 8C illustrates a reliable communications method used in the hierarchical area restricted network shown in FIG. 8A. The nodes within the hierarchical area restricted network may communicate with each other. For example, the source node 8012 may send data to the target node 8022. They utilize the hierarchical area key of a common parent area restricted network (i.e., the area restricted network 800 shown in FIG. 8C) located in their upper layer to serve as a security key for carrying out encryption with respect to the communications between them. Here it should be noted that directly utilizing the hierarchical area key of the common parent area restricted network located in their upper layer to serve as the security key is just an example. Actually, it is also possible to indirectly utilize the hierarchical area key of a current area restricted network (i.e., the area restricted network 801 shown in FIG. C) to carry out the encryption with respect to the communications. That is, the hierarchical area key of the parent area restricted network 800 is generated by adopting the hierarchical area key of the current area restricted network (i.e., the area restricted network 801 shown in FIG. 8C), and the generated hierarchical area key of the parent area restricted network 800 serves as the security key for carry out the communications. In a word, a node located in a current area restricted network may communicate, by directly utilizing its detected hierarchical area key of its parent area restricted network, with a node covered by its parent area restricted network, and may also communicate, by indirectly utilizing an hierarchical area key of the current area restricted network, with the node covered by its parent area restricted network. In this way, it is possible to establish a reliable communications link between the source node 8012 and the target node 8022. Of course, the quality of the established communications link also depends on the wireless signal strength between the source node 8012 and the target node 8022.

In addition, this kind of communications link may include two cases, namely, (1) if the involved two nodes are located in a same area covered by their signals, then they may directly establish a communications link between them; and (2) if the involved two nodes are not located in the same area covered by their signals, then they may establish a communications link between them by causing the respective master nodes within the corresponding hierarchical area restricted network to carry out data forwarding (as shown in FIG. 8C).

As a result, all the nodes located in the whole hierarchical area restricted network may carry out reliable communications with each other. When a node provides a service to other nodes, the corresponding access authorization follows a strategy on the basis of the hierarchical area restricted network, and the strategy is that only some physical areas covered by the hierarchical area restricted network are authorized to access the service. For example, in FIG. 1B, the printer node 10-3 located in the area restricted network 10 of the conference room may provide its printing service to the whole conference room including the nodes located in the child area restricted networks 20-1 and 20-2 on the tables. However, a node located outside of the area restricted network 10 of the conference room cannot access the printing service provided by the printer node 10-3 located in the area restricted network 10 of the conference room.

As a result, an example of the authorization process on the basis of the hierarchical area restricted network may be as follows.

$$grant ( {S}^{′} , N , PSNode ) = \{ \begin{matrix}true , & POS ( {HAK}_{N} \geq POS ( {HAK}_{PSNode} ) & N is located in a lower or same layer \\ false , & POS ( {HAK}_{N} < POS ( {HAK}_{PSNode} ) & N is located in an upper layer\end{matrix}$$

Here, N refers to a current node N; PSNode refers to a node providing a service; and S′ refers to a set of detected hierarchical area keys.

According to the above equation, if the current node N is located in a layer lower than that in which the node providing the service is located or in a layer the same as that in which the node providing the service is located, that means the current node N is covered by the area restricted network in which the node providing the service is located, i.e., the current N is authorized to access the node providing the service. On the other hand, if the current node N is located in a layer upper than that in which the node providing the service is located, that means the current node N is not covered by the area restricted network in which the node providing the service is located, i.e., the current node N is not authorized to access the node providing the service.

As a result, according to the embodiments of the present invention, in a case where there is a hierarchical area restricted network, it is possible to ensure that devices located in the hierarchical area restricted network may carry out normal authorization, normal routing, and reliable communications.

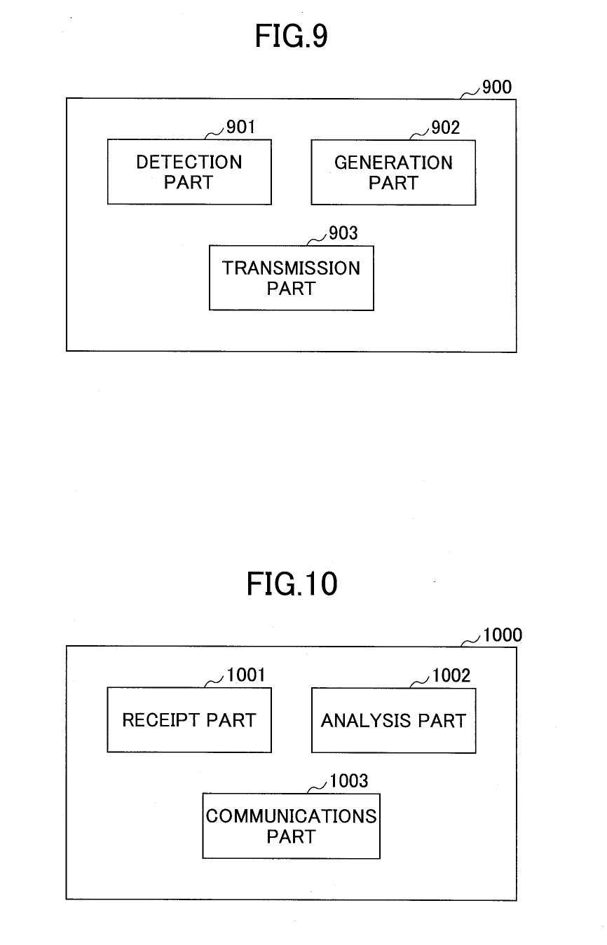

FIG. 9 is a block diagram of an area restricted network management device 900 according to an embodiment of the present invention.

As shown in FIG. 9, the area restricted network management device 900 includes a detection part 901, a generation part 902, and a transmission part 903. The detection part 901 is configured to detect, in a first area restricted network, one or more second area keys send from one or more second area restricted networks. The generation part 902 is configured to generate a first hierarchical area key. Here, the first hierarchical area key is related to a first area key generated by the first area restricted network as well as at least one of the detected one or more second area keys. The transmission part 903 is configured to transmit the first hierarchical area key to the inside of the first area restricted network.

FIG. 10 is a block diagram of an area key receipt device 1000 in a first area restricted network, according to an embodiment of the present invention.

As shown in FIG. 10, the area key receipt device 1000 includes a receipt part 1001, an analysis part 1002, and a communications part 1003. The receipt part 1001 is configured to receive one or more second hierarchical area keys sent from one or more second area restricted networks. The one or more second hierarchical area keys are managed by the above-described area restricted network management method.

The analysis part 1002 is configured to analyze the one or more hierarchical area keys so as to determine in which second area restricted network(s) the area key receipt device 1000 is located. The communications part 1003 is configured to utilize a first hierarchical area key managed by the above-described area restricted network management method or the one or more second hierarchical area keys to communicate with one or more devices located in the inside of the determined second area restricted network(s).

As a result, according to the embodiments of the present invention, in a case where there is a hierarchical area restricted network, it is possible to ensure that devices located in the respective area restricted networks may carry out normal authorization, normal routing, and reliable communications.

Here it should be noted that an embodiment of the present invention may also include parts configured to achieve the steps of the above-described methods, respectively. For the sake of convenience, the descriptions of the parts are omitted here.

Furthermore, sometimes any one of the above-mentioned “area key”, “hierarchical area key”, “area security key”, and “security key” for carrying out reliable communications may be replaced by another one of them. The reason is that these kinds of keys include information by which verification may be carried out, and sometimes any one of these keys may be converted to another one of them by utilizing some algorithms.

Here it should be noted that the above respective embodiments are just exemplary ones, and the specific structure and operation of each of them may not be used for limiting the present invention.

Moreover, the embodiments of the present invention may be implemented in any convenient form, for example, using dedicated hardware, or a mixture of dedicated hardware and software. The embodiments of the present invention may be implemented as computer software implemented by one or more networked processing apparatuses. The network may comprise any conventional terrestrial or wireless communications network, such as the Internet. The processing apparatuses may comprise any suitably programmed apparatuses such as a general purpose computer, personal digital assistant, mobile telephone (such as a WAP or 3G-compliant phone) and so on. Since the embodiments of the present invention can be implemented as software, each and every aspect of the present invention thus encompasses computer software implementable on a programmable device.

The computer software may be provided to the programmable device using any storage medium for storing processor-readable code such as a floppy disk, a hard disk, a CD ROM, a magnetic tape device or a solid state memory device.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present invention is described with reference to the specific embodiments chosen for purpose of illustration, it should be apparent that the present invention is not limited to these embodiments, but numerous modifications could be made thereto by those people skilled in the art without departing from the basic concept and technical scope of the present invention.

The present application is based on and claims the benefit of priority of Chinese Priority Patent Application No. 201310435574.7 filed on Sep. 23, 2013, the entire contents of which are hereby incorporated by reference.

What is claimed is:

1. An area restricted network management method comprising:
detecting, in a first area restricted network, one or more second area keys sent from one or more second area restricted networks;
generating a first hierarchical area key which is related to a first area key generated by the first area restricted network as well as at least one of the detected one or more second area keys; and
transmitting the first hierarchical area key to inside of the first area restricted network.

2. The area restricted network management method according to claim 1, further comprising one of:
letting a device located in the inside of the first area restricted network utilize the first hierarchical area key or the first area key to communicate with another device located in the inside of the first area restricted network;
utilizing the first hierarchical area key or the first area key to carry out an authorization process with respect to an unauthorized node that has entered the inside of the first area restricted network; and
letting a device located in the inside of the first area restricted network utilize the first hierarchical area key or the detected one or more second area keys to communicate with other devices located in the one or more second area restricted networks.

3. The area restricted network management method according to claim 1, wherein:
the first area key generated by the first area restricted network is related to an identification of the first area restricted network as well as an area security key for carrying out communications in the inside of the first area restricted network.

4. The area restricted network management method according to claim 1, wherein:
the first hierarchical area key is a set of the first area key and at least one of the detected one or more second area keys.

5. The area restricted network management method according to claim 1, wherein:
the one or more second area keys include one or more second hierarchical area keys; and
at least one of the detected one or more second area keys includes a second hierarchical area key of a second area restricted network located in a layer upper than that in which the first area restricted network is located.

6. The area restricted network management method according to claim 5, wherein:
the detecting, in a first area restricted network, one or more second area keys sent from one or more second area restricted networks comprises
determining which one of the one or more second area keys is one sent from the second area restricted network located in the layer upper than that in which the first area restricted network is located; and
the generating a first hierarchical area key comprises
generating a first hierarchical area key which is related to a second area key, that is determined as sent from the second area restricted network located in the layer upper than that in which the first area restricted network is located, as well as the first area key generated by the first area restricted network.

7. The area restricted network management method according to claim 6, wherein:
the determining which one of the one or more second area keys is one sent from the second area restricted network located in the layer upper than that in which the first area restricted network is located comprises
determining one of the one or more second area keys, whose number of related keys is maximum, to serve as one sent from the second area restricted network located in the layer upper than that in which the first area restricted network is located.

8. An area key receipt method comprising:
receiving, in a first area restricted network, one or more second hierarchical area keys sent from one or more second area restricted networks, wherein, the one or more second hierarchical area keys are managed by the area restricted network management method according to claim 1;
analyzing the one or more second hierarchical area keys so as to determine in which second area restricted network or networks a device in the first area restricted network is located; and
communicating, by the device in the first area restricted network, with one or more devices in the determined second area restricted network or networks by utilizing a first hierarchical area key managed by the area restricted network management method according to claim 1 or the one or more second hierarchical area keys.

9. An area restricted network management device comprising:
a detection part configured to detect, in a first area restricted network, one or more second area keys sent from one or more second area restricted networks;
a generation part configured to generate a first hierarchical area key which is related to a first area key generated by the first area restricted network as well as at least one of the detected one or more second area keys; and
a transmission part configured to transmit the first hierarchical area key to the inside of the first area restricted network.

10. An area key receipt device comprising:
a receipt part configured to receive, in a first area restricted network, one or more second hierarchical area keys sent from one or more second area restricted networks, wherein, the one or more second hierarchical area keys are managed by the area restricted network management method according to claim 1;
an analysis part configured to analyze the one or more second hierarchical area keys so as to determine in which second area restricted network or networks the area key receipt device is located; and
a communications part configured to communicate with one or more devices in the determined second area restricted network or networks by utilizing a first hierarchical area key managed by the area restricted network management method according to claim 1 or the one or more second hierarchical area keys.
